(19) United States
(12) Patent Application Publication
(10) Pub. No.: US 2010/0072143 A1
(43) Pub. Date: Mar. 25, 2010

(54) WATER TREATMENT SYSTEM

(76) Inventors: Bernard Jacobs, Noordhoek (ZA); Ian Douglas Vroom, Cape Town (ZA)

Correspondence Address: STITES & HARBISON PLLC, 1199 NORTH FAIRFAX STREET, SUITE 900, ALEXANDRIA, VA, 22314, US

(21) Appl. No.: 12/597,656

(22) PCT Filed: Apr. 25, 2008
(86) PCT No.: PCT/IB08/51604

§ 371 Date: Dec. 4, 2009

(51) Int. Cl. C02F 1/78; C02F 1/00; C02F 1/461

(52) U.S. Cl. 210/748.19; 210/808; 210/747; 210/748.18; 210/760; 210/137

(57) ABSTRACT

The invention provides a method for reducing aquatic organic contamination present in a volume of water, the method comprising: pumping the water from an open body of water contaminated with aquatic organisms through a reactor unit including a conduit system of varying diameter such that the pressure head in the water is caused to fall to a level below atmospheric pressure, and so to cavitate, at a point in the system by increasing the velocity head of the water at that point. The invention also includes apparatus for use in the method.

### FIELD OF THE INVENTION

THIS INVENTION relates to the treatment of water in order to eliminate aquatic organisms present in the water by destroying these organisms or reducing their numbers to the point where they are unviable as colonies. The invention has particular application in the treatment of ballast water carried by ships, which may give rise to undesirable environmental effects when discharged into seas or lakes distant from the sites where water was taken on board.

### BACKGROUND TO THE INVENTION

Modern ships generally carry ballast water in tanks within their hulls to balance and stabilise the ship and to promote its manoeuvrability. As cargo is taken aboard and settles the ship in the water, ballast water is discharged. Likewise, when cargo is off-loaded, ballast water is pumped into the ballast tanks to maintain the desired equilibrium.

It is well known that, because the volumes of water pumped in and out of ships on this basis are large, and because numerous species of organisms inhabit the waters in which ballast water is taken aboard and discharged, there has been a long history of the release into both seawater and fresh water of alien species, often taken from a distant location. These organisms range from minute plankton species to sizeable pelagic fishes, and include various pathogenic bacteria and micro-organisms (protozoa), present at all stages of their breeding cycle. Some of them have few natural predators in the waters in which they arrive, and if they find a suitable food source in these waters they rapidly colonise their new territory and may begin to dominate it. They may thus become a pest and a threat to the stability of the ecology of their new habitat.

The problem is recognised worldwide as a serious threat to the aquatic environment, and the International Maritime Organisation (“IMO”) concluded a treaty in February 2004 which will have the effect of requiring ship-owners to take rigorous and systematic steps to sterilise the ballast water in their vessels. The treaty is in the course of ratification, and concrete provisions regarding the technologies to be applied in implementing it are still under consideration.

The applicant previously filed South African patent application number 2005/10473 (published on 3 May 2007 under WO 2007/049139), describing a ballast water treatment system based on cavitation in combination with chemical biocidal activity caused by chlorine and other gases produced by electrolysis and the introduction of ozone. Although each of these processes individually is known for use in the treatment of ballast water, and was so at the date on which 2005/10473 was filed, the combination disclosed therein was not known, and the effects of the interactions between these processes were not known or understood.

### BRIEF DESCRIPTION OF THE INVENTION

According to a first aspect of the invention, there is provided a method of treating ballast water onboard a ship, the method comprising drawing water into an inlet in piping provided onboard the ship from a body of water in which the ship is located (typically, although not essentially, from a sea chest in fluid communication with the body of water), passing the water along the piping and through a cavitation-causing reactor, configured to cause cavitation in the water as it passes through the reactor, and discharging the water through the piping into a ballast tank in the ship; the method being characterised in that the water is caused to flow through the piping by means of a pump situated in line along the piping, downstream of the cavitation-causing reactor.

According to a second aspect of the invention, there is provided a method of treating ballast water onboard a ship, the method comprising: pumping the water through a reactor; electrolysing the water in the reactor so as to introduce sodium hypochlorite into the water in a quantity of between 0.4 and 1.0 milligrams per litre of water passing through the reactor; and causing the water in the reactor to cavitate.

According to a third aspect of the invention, there is provided a method of treating ballast water onboard a ship, the method comprising: pumping water having therein a concentration of living organisms from a body of water in which the ship is situated; reducing the concentration of living organisms to meet the criteria laid down in Regulation D-2 of the Annex “Regulations for the control and management of ships' Ballast Water and Sediments” to the IMO Ballast Water Convention 2004 by causing the water to cavitate with a combination of cavitation and electrolysis; and discharging the treated water into a ballast tank aboard the vessel.

The water may be pumped through the reactor at a volumetric flow rate of between 160 and 320 m³ per hour, and preferably at about 280 m³ per hour. Alternatively, in the case of a larger reactor, the water may be pumped through the reactor at a volumetric flow rate of between 450 and 1000 m³ per hour, and preferably at about 640 m³ per hour. The water may be pumped through the reactor at a mean velocity of between 2 and 3.5 metres per second, and preferably at about 3 metres per second.

The electrolysis reaction may be configured to produce sodium hypochlorite in a quantity of between 0.4 and 1.0 milligrams per litre, and preferably in a quantity of 0.5 milligrams per litre of water.

Additionally, ozone may be introduced into the water. The ozone may be introduced into the water in a quantity of between 0.001 and 0.1 g per litre, and preferably in a quantity of about 0.01 g per litre. The ozone may be generated onboard the ship, preferably by way of corona discharge ozone generation. Alternatively, the ozone may be generated by way of ultraviolet or other known ozone generation methods. Preferably, the ozone is introduced into the water before the water is caused to cavitate.

The water may be caused to cavitate, whether continuously or intermittently, for a distance of between 2 and 3 metres along the course of its flow through the reactor. The water may be caused to cavitate, whether continuously or intermittently, for a period of between 1 seconds and 5 seconds, and preferably for about 5 seconds.

According to a further aspect of the invention, there is provided apparatus configured for treatment of ballast water in a ship, comprising a cavitation-causing reactor, configured for generating cavitation in water flowing therethrough, located in line in piping extending between a sea chest and ballast tank of the ship, and a pump for pumping the water along the piping from the sea chest to the ballast tank through the cavitation-causing reactor; the apparatus being characterized in that the pump is located in line along the piping, downstream of the cavitation-causing reactor.

According to a further aspect of the invention, there is provided apparatus configured for treatment of ballast water in a ship, comprising a reactor suitable to be placed in line in piping extending between a sea chest and ballast tank of the ship, the reactor including at least one pair of electrodes configured for electrolysing water flowing from the sea chest to the ballast tank through the reactor, and means for inducing cavitation into the flowing water.

The means for inducing cavitation may include variations in diameter in conduits in the reactor, and vanes, plates and/or other obstructions placed in the flow path of the water and calculated to induce cavitation.

The apparatus may additionally comprise a filter, suitable for removing particulate matter from the water.

The reactor may comprise a plurality of modules, each module including one of: at least one pair of electrodes configured for electrolysing water flowing from the sea chest to the ballast tank through the reactor; means for inducing cavitation into the flowing water; or ozone injecting means.

The reactor may comprise a plurality of such modules, connected to one another in series.

Alternatively, where useful as a result of space or other constraints, the reactor may comprise a plurality of such modules, connected in series with a section of pipe connecting one of such modules to another of such modules.

According to further aspect of the invention, there is provided a kit, comprising a plurality of such modules configured for assembly into a reactor as defined hereinabove.

According to another aspect of the invention, there is provided apparatus comprising a plurality of reactors as described herein, connected in parallel via a manifold.

The term “reactor” in this specification is used to denote a system located in line along a section of piping, wherein a water treatment process is applied, be that electrolysis, direct injection of biocidal gas, or cavitation. The applicant intends that these processes be applied in combination, and thus generally refers to a “reactor” as a single unit in which more than one of these processes are applied. However, in the case of a modular arrangement as described in this specification, where each module constitutes a “reactor” as herein defined, references to a “reactor” in the singular should be understood as references to a combination of such modules. Also, it should be understood that reference to a “cavitation-causing” reactor is intended to refer to a reactor configured to cause cavitation in water flowing through that reactor; and as such, a “cavitation-causing reactor” as referred to herein may or may not additionally include means for applying electrolysis, or the direct injection of biocidal gas.

### BRIEF DESCRIPTION OF THE DRAWINGS

In the accompanying drawings:

FIG. 1 is a schematic representation of a water treatment system of the invention, installed for shipboard use.

FIG. 2 is a side view of the reactor of the invention.

FIG. 3 is a side view of the reactor of FIG. 2, shown longitudinally sectioned.

FIG. 4 is a perspective view, on a reduced scale, of the reactor of FIG. 2.

FIG. 5 is a perspective view of a first module of the reactor of FIG. 2.

FIG. 6 is a perspective view, on a reduced scale, of a second module of the reactor of FIG. 2, including an exploded view.

FIG. 7 is an end view of a third module of the reactor of FIG. 2.

FIG. 8 is a sectioned side view of the third module shown in FIG. 7.

FIG. 9 is a perspective view of the third module shown in FIG. 7.

FIG. 10 is a perspective view of the fourth module of the reactor shown in FIG. 2.

FIGS. 10A, B and C are sets of views of alternative embodiments of fourth modules, being alternative to that shown in FIG. 10.

FIG. 11 is a block diagram of an electrical control panel for the system shown in FIG. 1.

FIG. 12 is an outline drawing of the electrical control panel module of FIG. 8.

FIG. 13 is a schematic representation of an alternative embodiment of a water treatment system of the invention, installed for shipboard use, configured for a ship having a pair of ballast tanks.

FIG. 14 is a table setting out the results of tests performed by the applicant.

### DETAILED DESCRIPTION OF THE DRAWINGS

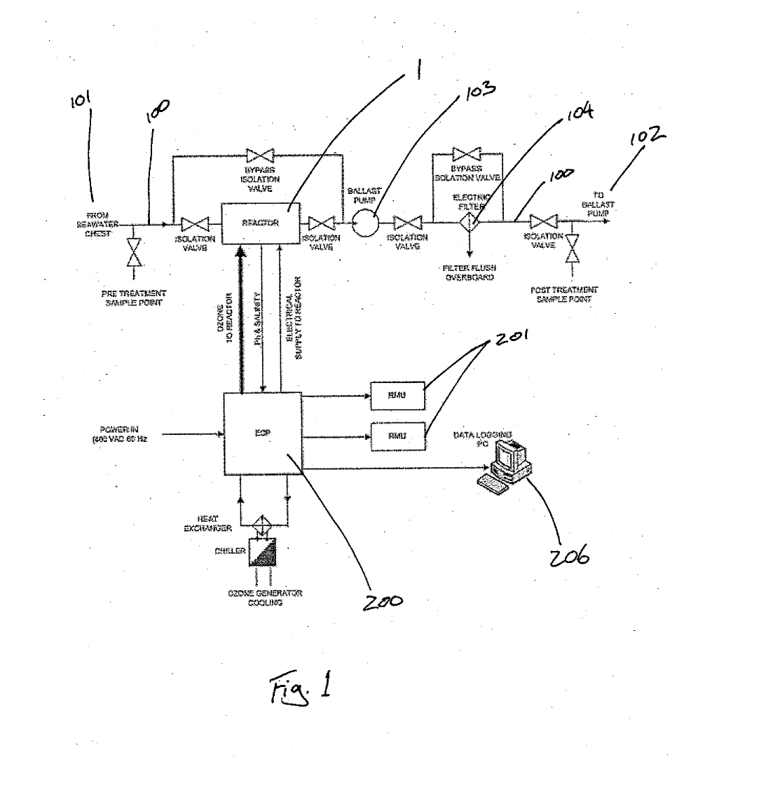

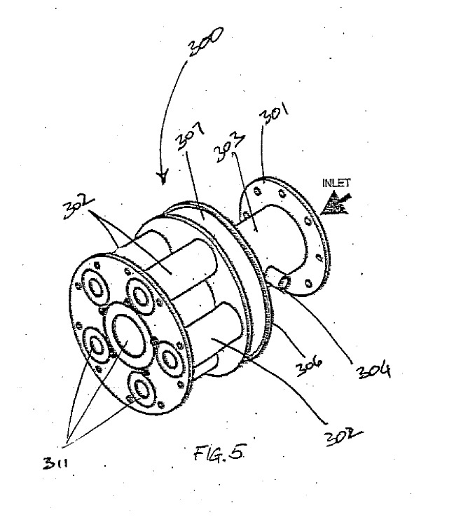

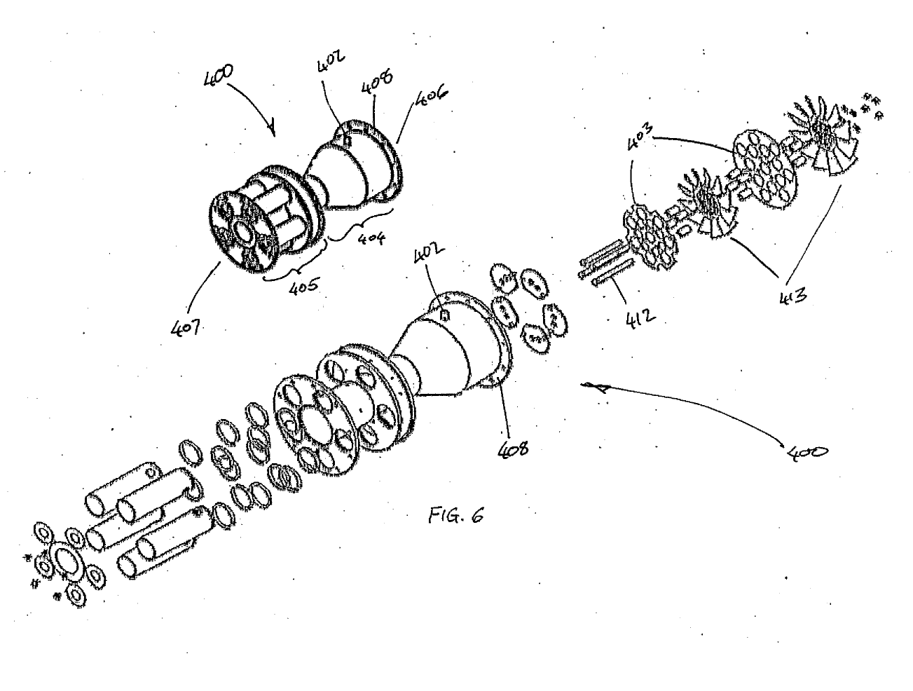

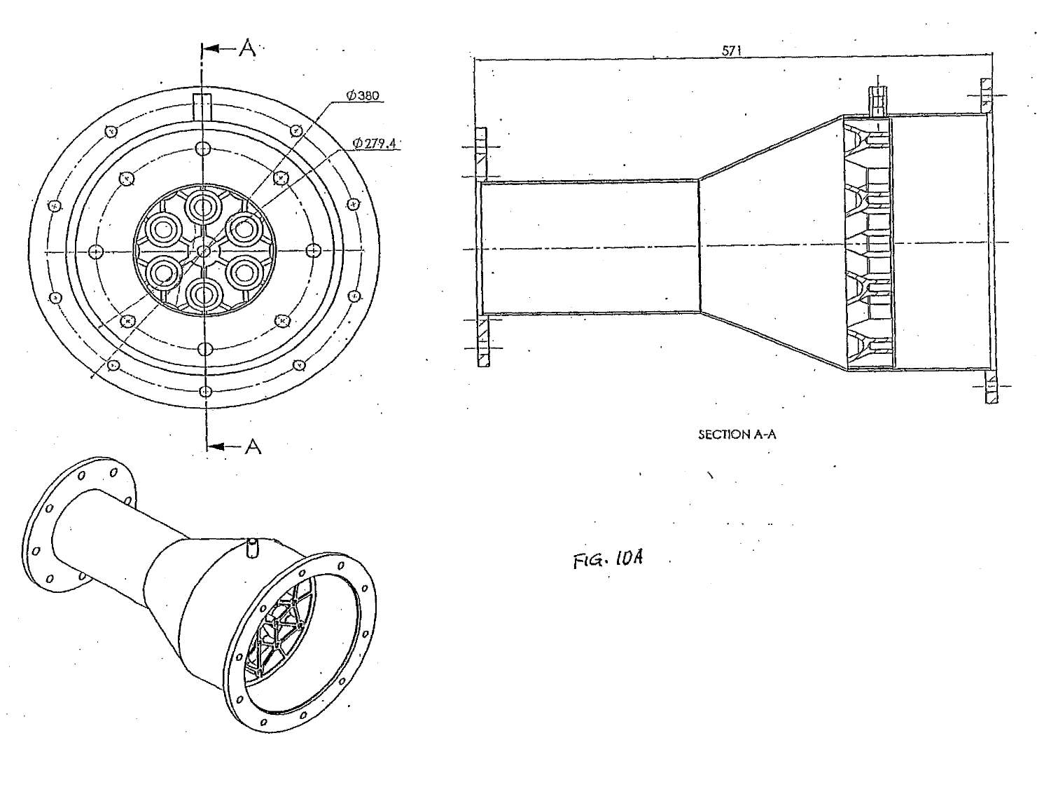

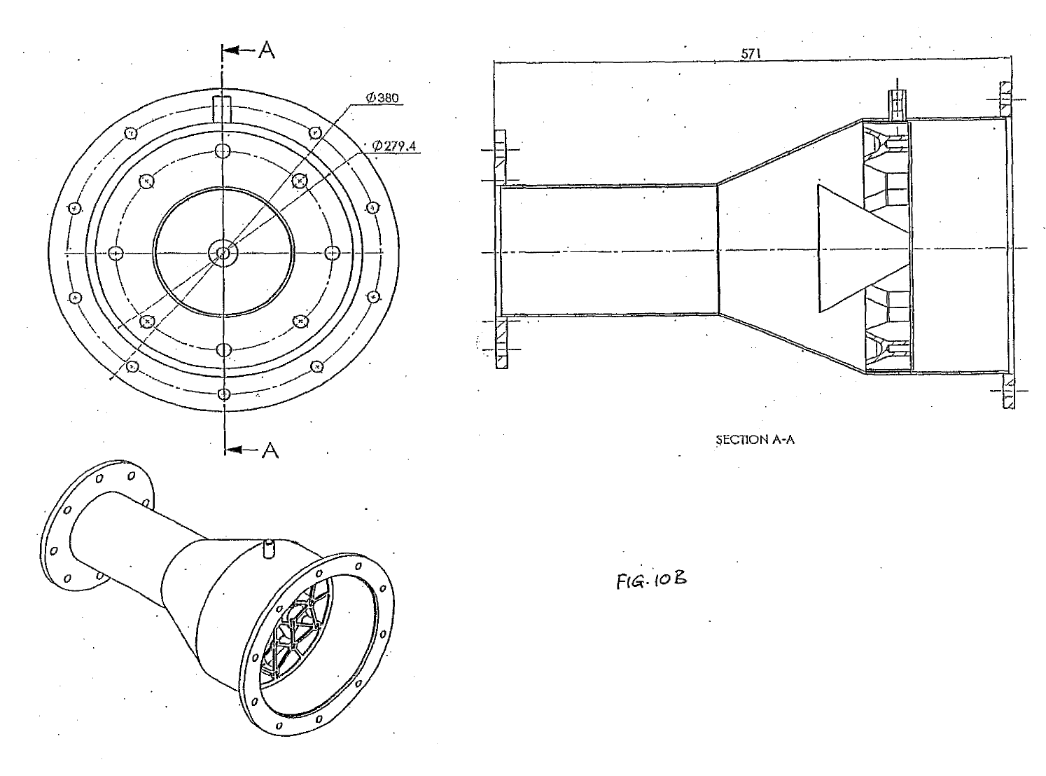

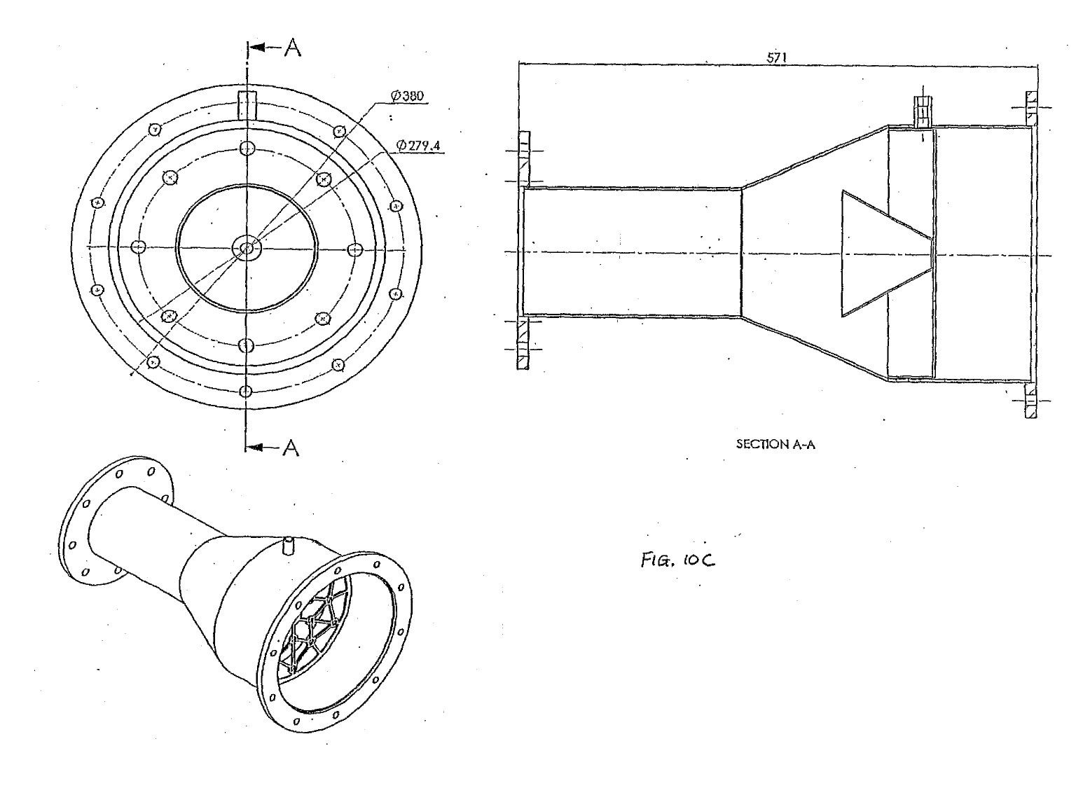

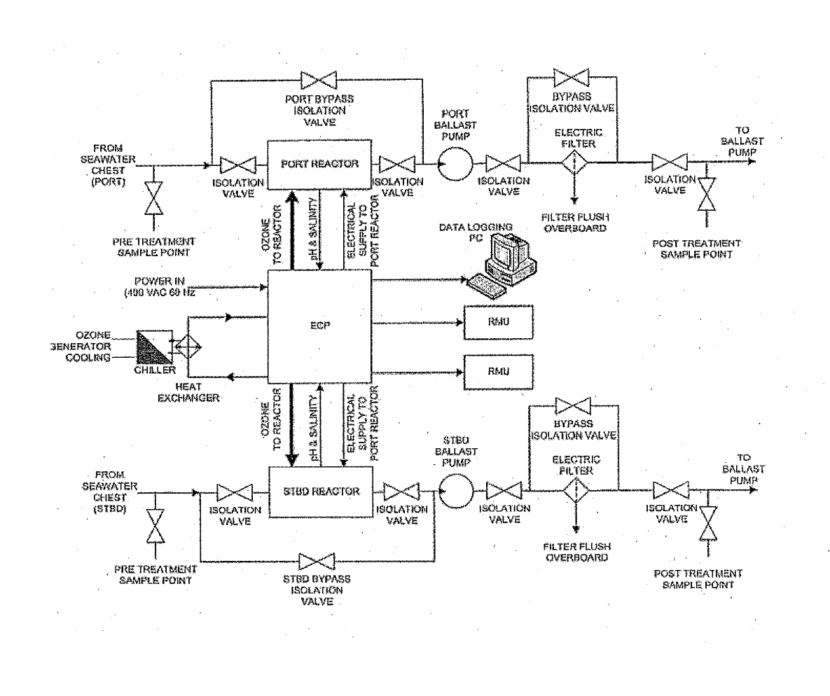

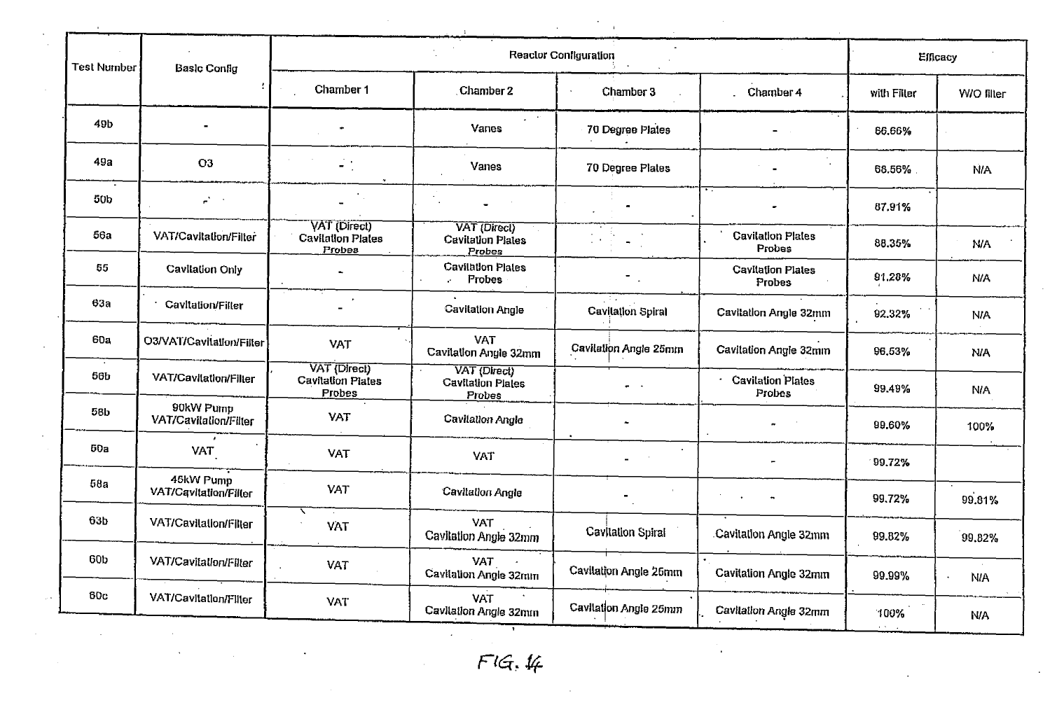

The apparatus illustrated in FIGS. 1-12 is a preferred embodiment of a water treatment apparatus suitable for treating the ballast water of a typical seagoing ship with conventional ballast tanks and a conventional ballast water pump. The apparatus is intended as an efficient, cost-effective system designed to meet the requirements of IMO Resolution MEPC 53/24.

The apparatus comprises a reactor 1 connected into piping 100 extending between a sea chest 101 and one or more ballast tanks 102 built into the ship. A ballast water pump 103 is also connected into the piping 100, preferably downstream of the reactor 1.

The reactor 1 is automatically controlled from an electrical control panel module 200, which is connected to one or more remote monitoring units 201.

The applicant is currently testing two models of the reactor 1—to suit installation in ships with 6-inch (15.2 cm) and 10-inch (25.4 cm) ballast water pipe systems respectively. (Differences between the two models are not generally significant, and except as pointed out, or would otherwise be understood by the skilled addressee, a distinction is not drawn between the models in this specification.) The amount of ballast water per hour that can be treated is dependent on model of reactor installed. For example, a 6-inch reactor can treat up to 320 m³ of ballast water per hour whereas a 10-inch reactor can treat up to 640 m³ per hour.

The automatic operation and remote monitoring allow the ship's crew to continue with their normal tasks while ballast water operations are in progress. In addition, the relatively small size makes the system an ideal choice for retrofit operations. A combination of reactors can be installed into a manifold, to upscale the output capacity of the reactor to the treatment rate capacity to suit the capacity of the ballast pumps installed on board a particular ship. Modular construction also allows modules of the reactor to be separated so as to permit installation in non-contiguous or awkward spaces.

The reactor 1 operates using three processes, namely:
introduction of ozone;
electrolysis; and
cavitation.

In the system of the invention, the ordinary operation of these processes requires only energy produced onboard the ship, and requires no input materials other than the air about the ship and water being treated itself.

Ozone is known to have biocidal properties, particularly in attacking cell walls, and has long been used in disinfection of potable water.

Electrolysis of seawater produces various gases such as hydrogen and oxygen, as well as particularly sodium hypochlorite and limited quantities of trihalomethanes and bromoform. Sodium hypochlorite particularly is known to have biocidal properties. Additionally, the electrical current induced into the water is believed to have a detrimental effect on certain organisms.

Further, the introduction of gases into the stream of ballast water before cavitation is believed to enhance the cavitation and its effects.

The term “cavitation” refers to the formation of vapor- or gas-filled cavities in liquids, and includes the familiar phenomenon of bubble formation when water is brought to a boil under constant pressure and the effervescence of champagne wines and carbonated soft drinks due to the diffusion of dissolved gases. In the present invention, however, the cavitation involved is caused by localized pressure reductions produced by the dynamic action of the flowing ballast water without change in ambient temperature. Cavitation in this context is characterized by an explosive growth and occurs at suitable combinations of low pressure and high speed in pipelines.

Additionally, the preferred embodiment of the invention also includes a filter 104, located in line along the piping 100 before the ballast water enters the ballast tanks 102.

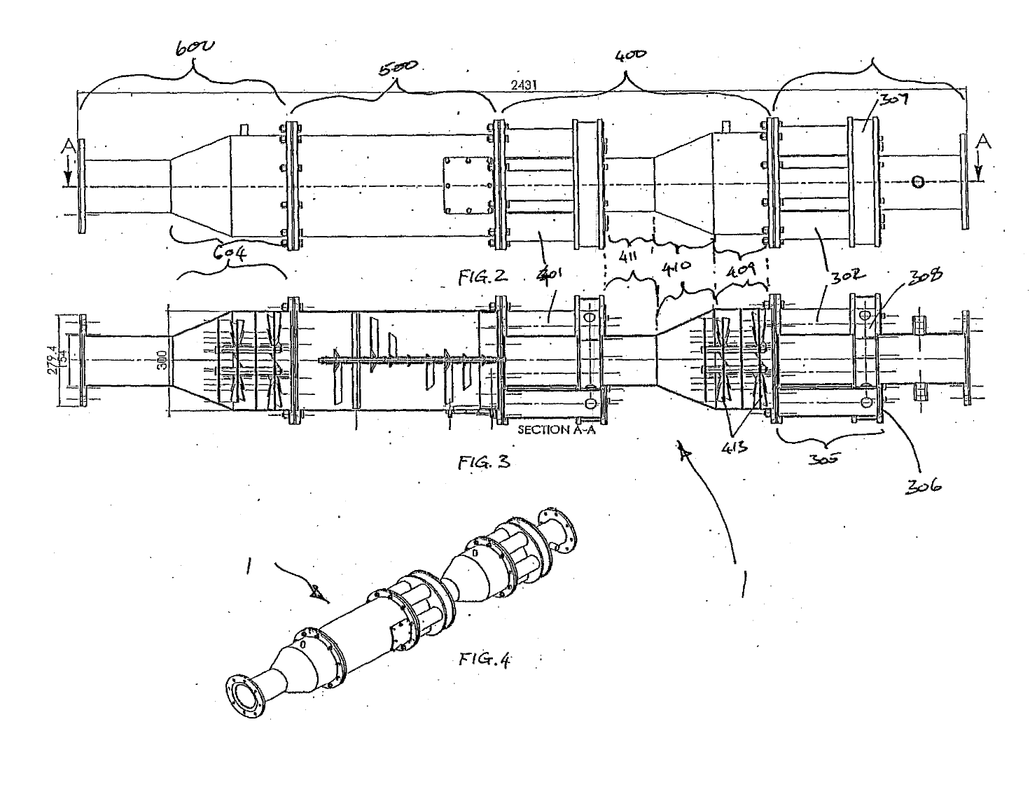

The reactor 1, as shown in FIG. 2, is manufactured from 316L stainless steel or from any other materials that are acceptable for ballast water pipe-lines, and comprises three modules, i.e. a first module 300, a second module 400, a third module 500 and a fourth module 600. Each module is connected to the other using M12 stainless steel bolts, washers and nuts (not shown). Watertight integrity is achieved by fitting water/chemical resistant gaskets (not shown) between the modules. Connection to the ship's ballast water piping 100 is via the standard flanges at the inlet 301 and outlet 601 to the reactor 1 respectively. Water/chemical resistant gaskets are supplied for these junctions. All flanges, joints, gaskets and welds are tested to specific pressures and temperatures to ensure compatibility and conformity to IMO requirements.

The internal surfaces of the reactor are treated with a ceramic spray-on epoxy type coating. The purpose of the protective coating is threefold:
To protect the interior surfaces of the reactor from corrosion caused by seawater;
To protect the inside surfaces from damage caused by cavitation generated within the system; and
To assist with the treatment of ballast water by generating a piezoelectric force that aids the working of the reactor.

The ozone gas is fed into the first module 300. Each of the first module 300 and the second module 400 has a bank of five electrodes (the electrodes not shown, but located in electrode housings 302, 401). The second module 400, the third module 500, and the fourth module 600, each include cavitation plates 403, 413, 603, and each of the second module 400 and the fourth module 600 have sample points 402, 602 for the connection of sensors (pH and water salinity) and from which water samples can be taken if required.

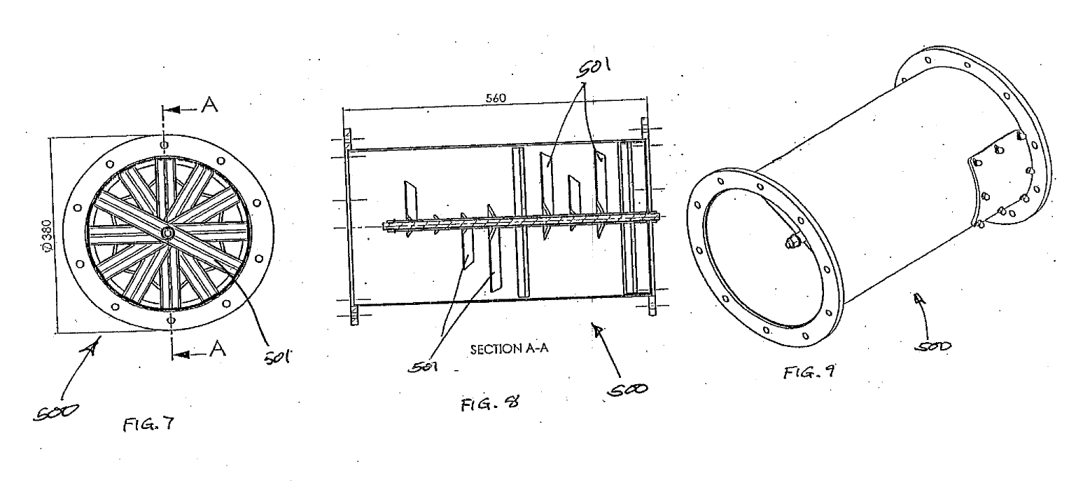

The first module 300, as shown particularly in FIG. 5, is connected to the piping 100 by means of flange 301. The first module 300 has an inlet section 303, having a diameter corresponding substantially to the diameter of the piping 100. The inlet section 303 is provided with an ozone gas inlet 304, operatively connected to the ozone gas generator 202. The ozone gas is infused into the ballast water by means of a Venturi injector (not shown). Following the inlet section 303, the first module 300 has an electro-chemical reactor section 305, wherein electrolysis takes place. At an upstream end thereof, the electro-chemical reactor section 305 has an annular plate 306 extending outwardly from the inlet section 303. Downstream of the inlet section 303, the electrochemical reactor section 305 has a cylindrical wall 307 extending from the annular plate 306, defining a manifold section 308 of increased diameter relative to that of the inlet section 303. Continuing downstream, the electro-chemical reactor section 305 has a central pipe section 309 and five, peripherally spaced, electrode housing pipe sections 302, all in fluid communication with the manifold section 308. First annular plate 306 is provided with ports (not shown), spaced evenly thereabout, and corresponding in location to the electrode housing pipe sections 302. Each of the ports is provided with a corresponding electrode mounting plate (not shown), fitting into the port, to which one or more electrodes (not shown) is mounted. In operation, with the electrode mounting plates fitted into the ports, the electrodes extend along the electrode housing pipe sections 302. This arrangement of the electro-chemical reactor section renders the electrodes readily accessible for maintenance work. The first module 300 has at its downstream end a flange 310, having orifices 311 therein allowing fluid communication from the central pipe section 309 and the electrode housing pipe sections 302.

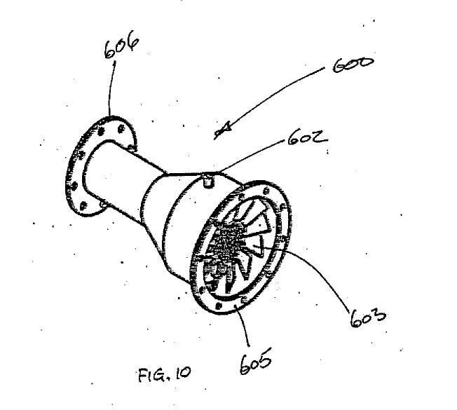

The second module 400 includes a cavitation chamber 404 and a further electro-chemical reactor 405. The second module 400 has an upstream end 406 and a downstream end 407. At the upstream end 406, the second module is provided with a flange 408, for connection to the first module 300. The cavitation chamber 404 has a cylindrical section 409, having a diameter roughly that of the manifold section 308 of the first module 300. Following the cylindrical section 409, the cavitation chamber 404 has a frusto-conical section 410, decreasing in diameter to meet a reduced diameter pipe section 411, having a diameter corresponding to the diameter of the piping 100. Inside the cavitation chamber 404, the second module 400 is provided with four rods 412, extending parallel to a longitudinal axis of the second module 400, on which are mounted a pair of vane plates 413 and a pair of cavitation plates 403. The vane plates 412 have a set of blades about their periphery, inclined so as in operation to impart a helical swirl to passing water. The cavitation plates 403 as shown in FIG. 6 each comprise a plate with a plurality of small orifices. Tubular spacers 414 are also provided, for setting the positions of the vane plates 412 and cavitation plates 403 along the rods 412.

In the wall of the cavitation chamber 404, there is provided an outlet 402 for monitoring purposes.

The further electro-chemical reactor 405 of the second module 400 is substantially the same as the electro-chemical reactor 305 of the first module 300.

The third module 500 comprises an extended tube defining a cavitation chamber, corresponding in diameter to cylindrical section 409. The third module 500 includes a set of cavitation plates 501. In the embodiment shown, these comprise an array of angled sections. Although shown with the apex of the angle sections pointing upstream, experiments by the applicant have shown that cavitation plates of this kind are more effective when reversed, with the apex pointing downstream.

The fourth module 600 comprises a cavitation chamber 604, substantially similar to the cavitation chamber 404 of the second module 400, and is provided at each end with a flange 605, 606 for connection to the third module 500 and piping 100 respectively. The fourth module 600 is also provided with an outlet 602 for monitoring purposes.

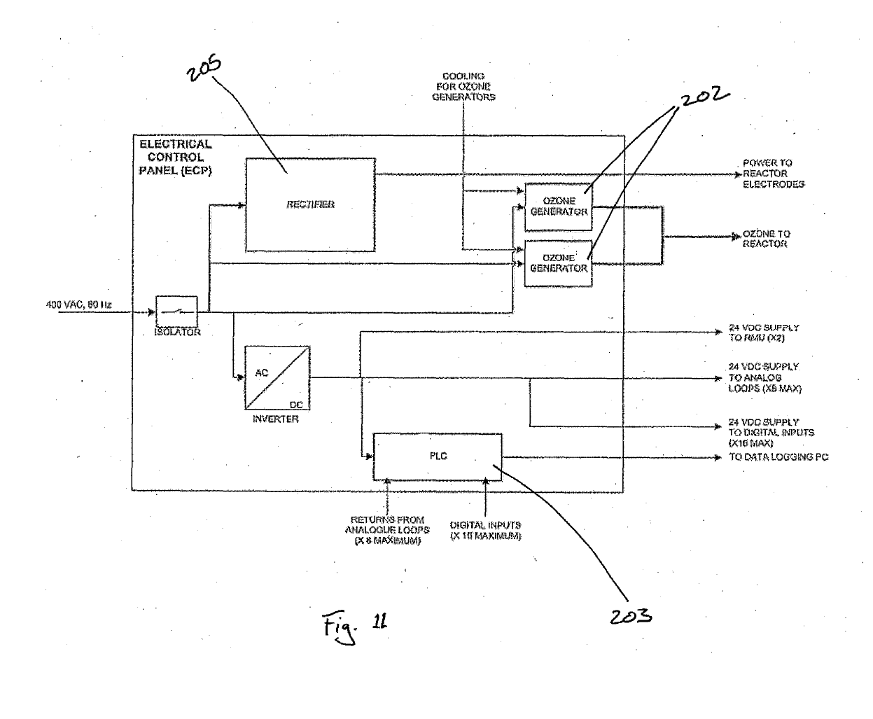

Alternative embodiments of the fourth module are shown in FIGS. 10A, B and C. these alternative embodiments have differently configured cavitation plates. It will be appreciated that various configurations of cavitation plates described in this specification might be used in any of the molecules designed to induce cavitation.

The system uses a BallastSafe BSEcH-1.0 filtration system 104 to remove particles, bodies and organisms from the water. Ballast water is passed through the filter 104 from the ballast pump 103. The filter 104 may be fitted at any position in the pipe prior to any branch in the pipe and before it enters the ballast water tank 102. The filtration system 104 can connect to the ballast water pipe work 100 either by means of standard flanges or specific pipe couplings. The ballast water enters the filtration system 104 through the inlet pipe and passes first through a coarse screen to remove any large particles and then through a fine screen, preferably 40 micron. Cleaning of the screens is carried out as follows:
Coarse screen is flushed on receipt of flushing command (recommended every four hours).
Fine screen can be flushed either on receipt of flushing command (recommended every two hours) or when a preset differential pressure across the screen is detected.

The “filter cake” flushed from the filter screens can be pumped directly overboard.

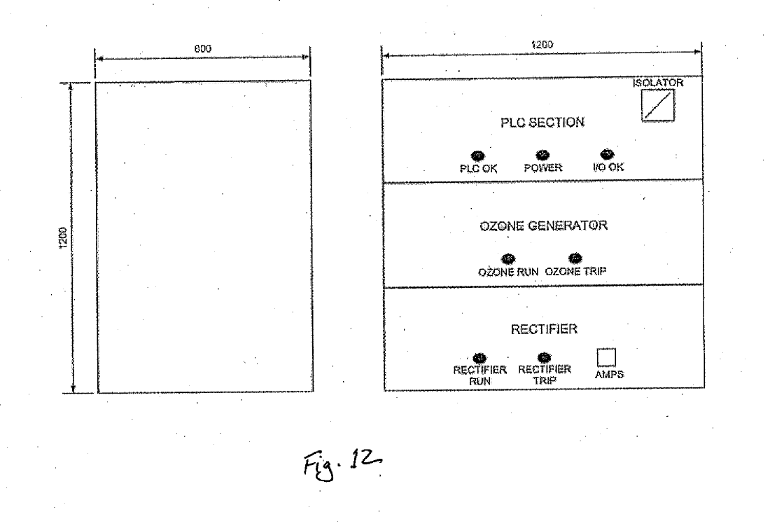

A block diagram of the electrical control panel module 200 is shown in FIG. 11. The equipment of the electrical control panel module 200 comprises a programmable logic controller (“PLC”) 203, control switchgear 204, a rectifier 205, and a pair of ozone generators 202, with chillers to control and maintain ozone output and temperature. The electrical control panel module 200, is housed in a marine approved watertight electrical box. The electrical supply to the electrical control panel module 200 should be routed via the control switchgear of the ballast water pump 103 that it operates in conjunction therewith. Adopting this configuration ensures that the system is operational immediately the ballast water pump 103 is started. The PLC 203 controls the working cycle and manages all monitoring and warning alarms of the reactor 1. The PLC 203 control enables access to all aspects of the reactor 1. Outputs available from the PLC enable real-time running and individual reactor component conditions to be connected to a local PC 206 thus allowing complete monitoring of the reactor 1. Electrode condition, water temperature, reactor operational state and ballast water flow rate are also monitored via the PLC 203 and recorded on the PC 206. The PLC 203 can monitor up to eight analogue loops and 16 digital inputs, allowing individual user's requirements to be handled. In the event of faults, the PLC 203 initiates audio and visual warnings which are displayed or sounded at the remote monitoring units 201. These would be located for example, at the reactor installation, in the ballast control room and on the bridge. Actions in response to these warning messages, e.g. emergency stopping of the reactor, bypass, etc are done directly from the ballast control room or bridge using the remote monitoring unit controls 201. If required, the PLC 203 can link into existing ballast water control room circuits and also directly to the bridge, thereby allowing the officer of the watch complete control of the reactor and ballast water operations. The electrical control panel module 200 is fitted with a 110 Amp/48 V rectifier 205 which supplies power to the electrodes in the reactor 1, via a heavy-duty DC electrical cable. The output polarity of the rectifier 205 is automatically switched under the control of the PLC 203. This polarity changeover ensures that deposits do not form on the electrodes. Two ozone generators 202 are mounted within the electrical control panel module 200. Each generator 202 comprises electronic circuit boards, a power module, high frequency transformer, electrodes and an ozone reactor (corona discharge tube). A chiller unit is provided to maintain ambient air and ozone generator temperature.

From the generators 202, the ozone gas is piped to the reactor 1 and infused into the ballast water by means of a Venturi system that becomes operational once the reactor is powered. in the system, the ozone gas is contained within the ballast water and dissolves within a matter of seconds in seawater. A Teflon pipe encased in a stainless steel conduit is used to route the ozone to the reactor. Non-return valves are fitted to ensure that the ozone does return into the delivery system. This configuration ensures that no ozone gas is released into the surrounding air, thus eliminating or vastly reducing any possibility of danger to the ships crew.

Cooling for the ozone generators 202 is supplied via a closed circuit system that incorporates a chiller and a heat exchange unit. A 10 mm diameter pipe is used for cooling system pipe-work with a series of non-return valves ensuring safety regarding the cooling system. The cooling system is activated via solenoids immediately the reactor 1 is switched on. Note that the cooling system serves a double purpose in that it provides cooling for the ozone generators and also cools the ambient air, from which the ozone gas is produced.

The ozone generators 202 have two types of input connectors for cooling water and output connectors for ozone, i.e. either ¼″ BSPT or ¼″ NPS Tapered.

The remote monitoring unit 201 comprises an intelligent graphic terminal with a graphic screen that works in conjunction with the PLC 203 to provide a means on controlling and monitoring the system.

Normally, the reactor 1 and filter 104 will start automatically when the corresponding ballast water pump 103 is started. Manual controls, however, are provided for use during maintenance or when required by the crew. Controls available are as follows:
Reactor Start/Stop
Filter Start/Stop
Bypass Open/Close

The following conditions will result in a warning display, accompanied by an audio alarm signal:
Reactor trip
Rectifier failure
Electrode failure or replacement required
Over-temperature.
Ozone Generator Failure (O₃ Generator 1 and O₃ Generator 2)

A rectifier failure or ozone generator failure warning is a critical warning as it indicates that the effectiveness of the system is compromised.

Preferably, the reactor 1 is fitted in-line into the inlet/suction side of the ship's ballast pump 103 and after the sea chest 101. It can, however, be installed after the ballast pump 103 if required. The reactor 1 can be installed in either a vertical or horizontal configuration. A plurality of reactors can be installed into a manifold/pod, to upscale the output capacity of the reactor to the treatment rate capacity to suit the capacity of the ballast pumps installed on board the particular ship. Filters 104 can be installed either horizontally or vertically.

In the embodiment shown, both the reactor and the filter require a 400V AC 60 Hz supply. As illustrated, the power consumption of the reactor and filter is about 7 kW for a 6 inch system. Naturally, the power requirements will vary according to the configuration of the ship and the flow rate of the system installed. Nevertheless, power consumption of 7-10 kW per 6 inch reactor unit is expected.

The individual modules are easily carried via a lift or by two installation technicians. No heavy lifting gear or equipment is required, although, for ease of installation, a 500 kg chain hoist or electrical hoist can be employed.

For installation in existing vessels it is important to note that the reactor 1 can be mounted in any attitude, i.e. vertical, horizontal or at any angle depending on the availability of space on board the vessel. The angle at which the unit is mounted or fitted into the pipeline will not affect the operational capability of the reactor. The reactor is modular and can be supplied in individual sections, taken to the identified installation site and assembled in-situ, i.e. no major alterations to the ship's structure are required. If in the vessel there is insufficient space available between the sea-chest and the ballast pump the reactor can be installed after the ballast pump. Alternatively, provision can be made for additional pipe work that could lead to the preferred location and then to return to the ballast water pump. Note that if this method were adopted, care would have to be taken to ensure that the additional pipe work, bends, etc. did not adversely affect the flow rate of ballast water through the system. In difficult installations, it may be possible install the three chambers in separate sections into the pipe work. With this type of installation, such factors as electrical connections to the separate sections would have to be considered.

The applicant has conducted various tests, the results of which are tabulated in FIG. 11. In FIG. 11, the descriptions, “Chamber 1”, “Chamber 2” and “Chamber 3” refer to the first module 300, the second module 400 and the fourth module 600 respectively. The description “Chamber 4” refers to the third module 500. The description “O3” indicates the tests in which ozone was introduced. The description “VAT” indicates the tests in which electrolysis was performed (the acronym VAT referring to the variable amperage transformer/rectifier used in the tests). Production versions of the reactor will be supplied with a rectifier giving a fixed, optimal output to the electrodes. With regard to test 50b, it should be noted that the configuration of diameters of the various sections within the reactor is such that cavitation is induced notwithstanding the absence of cavitation plates. The tests were performed using a 6-inch reactor, using a 45 kW pump, producing a flow rate through the reactor of 220 m³ per hour, except in the case of test 58b, in which a 90 kW pump was used, producing a flow rate through the reactor of 320 m³ per hour.

Having performed these tests, the applicant has concluded that the effectiveness of a cavitation-based system is enhanced by the addition of an electrolysis process, producing sodium hypochlorite and other gases. Although the tests performed in sea water were inconclusive as to whether or not further addition of the introduction of ozone into the water in the dosages contemplated by the applicant increases the effect of the cavitation-electrolysis combination described herein, the applicant envisages that the introduction of ozone will enhance the efficacy of the system in fresh water, where electrolysis will produce less, or no, biocidal gases. Further, when used in combination with a cavitation process, a significantly lower dose of biocidal gas than that provided in known prior art systems is required to achieve the required kill rate. This accordingly results in a lower power requirement, and lower amounts of potentially hazardous chemicals.

While the specification describes particular embodiments of the present invention, it will also be apparent to those of ordinary skill that various modifications can be made without departing from the spirit and scope of the invention.

1. A method for reducing aquatic organic contamination present in a volume of water, comprising: pumping the water from an open body of water contaminated with aquatic organisms through an elongate conduit system, the water having a volumetric flow rate that is the same at all points in the system, and having, at any point in the system, a pressure head and a velocity head; and directing the water into the tank; and characterized by pumping the water through a reactor unit including a conduit system of varying diameter such that the pressure head in the water is caused to fall to a level below atmospheric pressure, and so to cavitate, at a first point in the system by increasing the velocity head of the water at the first point.

2. A method as claimed in claim 1, wherein the water is discharged into a ship's ballast tank after being pumped through the reactor unit.

3. A method as claimed in claim 1, wherein the water is drawn through the reactor by means of a pump situated in line along the conduit system, downstream of the reactor.

4. A method as claimed in claim 3, wherein water is pumped through the reactor at a mean velocity of between 2 and 3.5 meters per second.

5. A method as claimed in claim 4, wherein water is pumped through the reactor at about 3 meters per second.

6. A method as claimed in claim 3, wherein water is pumped through the reactor at a volumetric flow rate of between 160 and 320 m³ per hour.

7. A method as claimed in claim 4, wherein water is pumped through the reactor at a volumetric flow rate of about 280 m³ per hour.

8. A method as claimed in claim 1, wherein water is pumped through the reactor at a volumetric flow rate of between 450 and 1000 m³ per hour.

9. A method as claimed in claim 6, wherein water is pumped through the reactor at a volumetric flow rate of about 640 m³ per hour.

10. A method as claimed in claim 1, wherein the water is electrolysed in the reactor so as to introduce sodium hypochlorite into the water in a quantity of between 0.4 and 1.0 milligrams per liter of water passing through the reactor.

11. A method as claimed in claim 3, wherein ozone is introduced into the water passing through the reactor.

12. A method as claimed in claim 11, wherein the ozone is introduced into the water in a quantity of between 0.001 and 0.1 g per liter.

13. A method as claimed in claim 12, wherein ozone is introduced into the water in a quantity of about 0.01 g per liter.

14. A method as claimed in claim 11, wherein the ozone is generated onboard the ship.

15. A method as claimed in claim 14 wherein the ozone is generated by way of corona discharge ozone generation.

16. A method as claimed in claim 11, wherein the ozone is introduced into the water before the water is caused to cavitate.

17. A method as claimed in claim 1, including the step of reducing the concentration of living organisms to meet the criteria laid down in Regulation D-2 of the Annex “Regulations for the control and management of ships' Ballast Water and Sediments” to the IMO Ballast Water Convention 2004 by causing the water to cavitate with a combination of cavitation and electrolysis, before discharging the treated water into a ballast tank aboard the ship.

18. An apparatus for reducing aquatic organisms in a body of water, comprising: a reactor having an elongate conduit system having an upstream end and a downstream end, and being configured to permit the water to flow therein at a constant volumetric rate, characterized in the conduit system defining portions that comprise: a first tapered portion having a generally frusto-conical shape, and having a downstream end defining a first opening having a first diameter, and an upstream end defining a second opening having a second diameter larger than the first diameter; and a first reactor portion having a generally cylindrical shape with a third diameter, larger than the first diameter, the first reactor portion being connected to the downstream end of the first tapered portion by a radially disposed connector, such that the diameter of the conduit system immediately increases abruptly downstream of the first opening in the tapered portion; wherein the first diameter is sized to initiate cavitation in water flowing downstream through the conduit system

19. Apparatus as claimed in claim 18, including a pump located in line along the conduit system, downstream of the reactor unit.

20. Apparatus as claimed in claim 19, wherein the reactor includes at least one pair of electrodes configured for electrolysing water flowing through the reactor.

21. Apparatus as claimed in claim 19, wherein the reactor includes ozone injecting means.

22. Apparatus as claimed in claim 21 wherein the ozone is generated by corona discharge.

23. Apparatus as claimed in claim 18, dimensioned and configured so as in operation to cause the water to cavitate, whether continuously or intermittently, for a distance of between 2 and 3 meters along the course of its flow through the conduit system.

24. Apparatus as claimed in claim 18, dimensioned and configured so as in operation to cause the water to cavitate, whether continuously or intermittently, for a period of between 1 and 5 seconds.

25. Apparatus as claimed in claim 19, dimensioned and configured so as in operation to cause the water to cavitate, whether continuously or intermittently, for a period of about 5 seconds.

26. Apparatus as claimed in claim 19, wherein the reactor comprises a plurality of modules, each module including one of: at least one pair of electrodes configured for electrolysing water flowing through the reactor; means for inducing cavitation into the flowing water; or ozone injecting means.

27. Apparatus as claimed in claim 26, wherein the reactor comprises a plurality of such modules, connected to one another in series.

28. Apparatus as claimed in claim 26, wherein the reactor comprises a plurality of such modules, connected in series with a section of pipe connecting one of such modules to another of such modules.

29. A module including one of: at least one pair of electrodes configured for electrolysing water flowing through the reactor; means for inducing cavitation into the flowing water; or ozone injecting means; the module being configured for inclusion in a reactor unit according to claim 26.

30. A kit, comprising a plurality of modules including one of: at least one pair of electrodes configured for electrolysing water flowing through the reactor; means for inducing cavitation into the flowing water; or ozone injecting means; the modules being configured for assembly into apparatus as claimed in claim 26.

31. Apparatus comprising a plurality of reactors according to claim 18, connected in parallel via a manifold.
